(19) United States
(12) Patent Application Publication
(10) Pub. No.: US 2018/0257393 A1
(43) Pub. Date: Sep. 13, 2018

(54) IMAGE PROCESSING DEVICE, IMAGE PROCESSING PROGRAM, AND PRINTING APPARATUS

(71) Applicant: SEIKO EPSON CORPORATION, Tokyo (JP)

(72) Inventors: Akito SATO, Matsumoto (JP); Takuma HAYASHI, Nagano (JP); Masahiro FUKAZAWA, Chino (JP)

(21) Appl. No.: 15/901,975

(22) Filed: Feb. 22, 2018

(30) Foreign Application Priority Data
Mar. 10, 2017 (JP) 2017-045661

(51) Int. Cl. B41J 2/21

(52) U.S. Cl. CPC B41J 2/2139; B41J 2202/21; B41J 2/2146; B41J 2/2142

(57) ABSTRACT

An image processing device, which generates recording data for causing a recording head which includes an overlapping portion in which nozzles of a first nozzle column and a second nozzle column are partially overlapped in a nozzle aligning direction of the nozzle column to eject liquid droplets, includes a predetermined inclination correction amount obtaining unit which obtains a predetermined inclination correction amount for correcting recording density which is changed when the recording head is inclined by a predetermined angle from a reference position, with respect to recording density of the liquid droplets using nozzles of the overlapping portion; an inclination angle obtaining unit for obtaining an inclination angle of the recording head from the reference position; and a recording data generating unit for generating the recording data so that recording density of the liquid droplets using the nozzles of the overlapping portion is corrected based on the predetermined inclination correction amount, and the inclination angle of the recording head.

### BACKGROUND

### 1. Technical Field

The present invention relates to a technology for a recording head in which a part of nozzles of a plurality of nozzle columns are overlapped.

### 2. Related Art

An ink jet printer, for example, forms dots on a matter for printing by ejecting ink droplets (example of liquid droplets) from nozzles according to recording data, by causing a plurality of the nozzles which are aligned in a predetermined nozzle aligning direction and a matter for printing (example of matter for recording) to perform a relative movement in a relative movement direction which intersects the nozzle aligning direction. In addition, a line printer which forms a printed image by transporting a matter for printing without moving nozzles which are disposed over the approximately entire width direction which intersects a transport direction of the matter for printing, since the printer performs printing at a high speed, is also known. Since nozzles are disposed over the approximately entire width direction of the matter for printing, there is a line printer provided with a recording head in which a plurality of head chips including a nozzle column are combined, and nozzles are overlapped at a joining portion of two head chips which are adjacent to each other. When causing the nozzles to be partially overlapped, an overlapping region in which dots are formed by a plurality of nozzle, and a non-overlapping region in which dots are formed by one nozzle are generated in the matter for printing.

In addition, a printing apparatus described in JP-A-2005-205691 reduces density unevenness by setting a correction value for correcting recording density of ink droplets in each of lines of dots which are formed along a relative movement direction of the nozzles, and correcting the recording density in each of the lines.

The above described correction value is obtained by measuring recording density of ink droplets in each line, on the premise that a recording head attached to a line printer is not inclined. There is a case in which a slight inclination occurs in the recording head of the line printer as a product, and due to this, there is a case in which recording density in an overlapping region becomes high or low, when recording density in a non-overlapping region is set to a reference. When recording density in the overlapping region becomes high, dark stripes occur in a printed image, and when recording density in the overlapping region becomes low, stripes of light color occur in a printed image. However, in order to obtain the above described correction value in each of products, it takes too much time, and is unrealistic.

The above described problem is also present in an apparatus other than the line printer, such as a serial printer.

### SUMMARY

An advantage of some aspects of the invention is to provide a technology in which banding which occurs in an overlapping region can be suppressed.

According to an aspect of the invention, there is provided an image processing device which generates recording data for causing a recording head which includes an overlapping portion in which nozzles of a first nozzle column and a second nozzle column are partially overlapped in a nozzle aligning direction of the nozzle column to eject liquid droplets, the device including a predetermined inclination correction amount obtaining unit which obtains a predetermined inclination correction amount for correcting recording density which is changed when the recording head is inclined by a predetermined angle from a reference position, with respect to recording density of the liquid droplets using nozzles of the overlapping portion; an inclination angle obtaining unit for obtaining an inclination angle of the recording head from the reference position; and a recording data generating unit for generating the recording data so that recording density of the liquid droplets using the nozzles of the overlapping portion is corrected based on the predetermined inclination correction amount, and the inclination angle of the recording head.

According to another aspect of the invention, there is provided an image processing program for generating recording data for causing a recording head including an overlapping portion in which nozzles of a first nozzle column and a second nozzle column are partially overlapped in a nozzle aligning direction of the nozzle column to eject liquid droplets, the program causing a computer to execute a function of obtaining a predetermined inclination correction amount for correcting recording density which is changed when the recording head is inclined by a predetermined angle from a reference position with respect to recording density of the liquid droplets using nozzles of the overlapping portion; a function of obtaining an inclination angle of the recording head from the reference position; and a function of generating recording data in which the recording data is generated so that recording density of the liquid droplets using the nozzles of the overlapping portion is corrected based on the predetermined inclination correction amount, and the inclination angle of the recording head.

According to still another aspect of the invention, there is provided a printing apparatus which includes a recording head including an overlapping portion in which nozzles of a first nozzle column and a second nozzle column are partially overlapped in a nozzle aligning direction of the nozzle column, a predetermined inclination correction amount obtaining unit which obtains a predetermined inclination correction amount for correcting recording density which is changed when the recording head is inclined by a predetermined angle from a reference position with respect to recording density of the ink droplets ejected from nozzles of the overlapping portion; an inclination angle obtaining unit for obtaining an inclination angle of the recording head from the reference position; and a recording density correcting unit for correcting recording density of the ink droplets using nozzles of the overlapping portion, based on the predetermined inclination correction amount, and the inclination angle of the recording head.

According to the above described aspects, it is possible to provide a technology in which banding which occurs in an overlapping region can be suppressed.

### BRIEF DESCRIPTION OF THE DRAWINGS

The invention will be described with reference to the accompanying drawings, wherein like numbers reference like elements.

FIG. 1 is a diagram which schematically illustrates a configuration example of a printing apparatus including an image processing device.

FIG. 2 is a diagram which schematically exemplifies main portions of a line printer as an ink jet printer.

FIG. 3 is a diagram which schematically illustrates an example in which an inclination occurs in a recording head which is attached to the ink jet printer.

FIG. 4 is a diagram which schematically illustrates an example in which recording density in an overlapping region is changed according to an inclination of a recording head.

FIG. 5 is a diagram which schematically illustrates an example of obtaining a predetermined inclination correction amount.

FIG. 6 is a diagram which schematically illustrates an example of obtaining a final inclination correction value in a unit of line of dots.

FIG. 7 is a flowchart which illustrates an example of correction value setting processing.

FIG. 8 is a diagram which schematically illustrates an example of forming an inclination angle detecting pattern from pattern data.

FIG. 9 is a diagram which schematically illustrates an example in which a sensor for detecting an inclination angle of the recording head is used.

FIG. 10 is a diagram which schematically illustrates an example of obtaining a final inclination correction value from a predetermined inclination correction amount in which a plurality of lines of dots are put together.

FIG. 11 is a flowchart which illustrates an example of recording data generating processing.

FIG. 12 is a diagram which schematically illustrates an example of obtaining a final inclination correction value from inclination correction values of a plurality of stages.

FIG. 13 is a flowchart which illustrates an example of correction value setting processing.

### DESCRIPTION OF EXEMPLARY EMBODIMENTS

Hereinafter, embodiments of the invention will be described. As a matter of course, the following embodiments are merely examples of the invention, and all of features illustrated in the embodiments are not essential in solutions in the invention.

### 1. Outline of Technology Included in Invention:

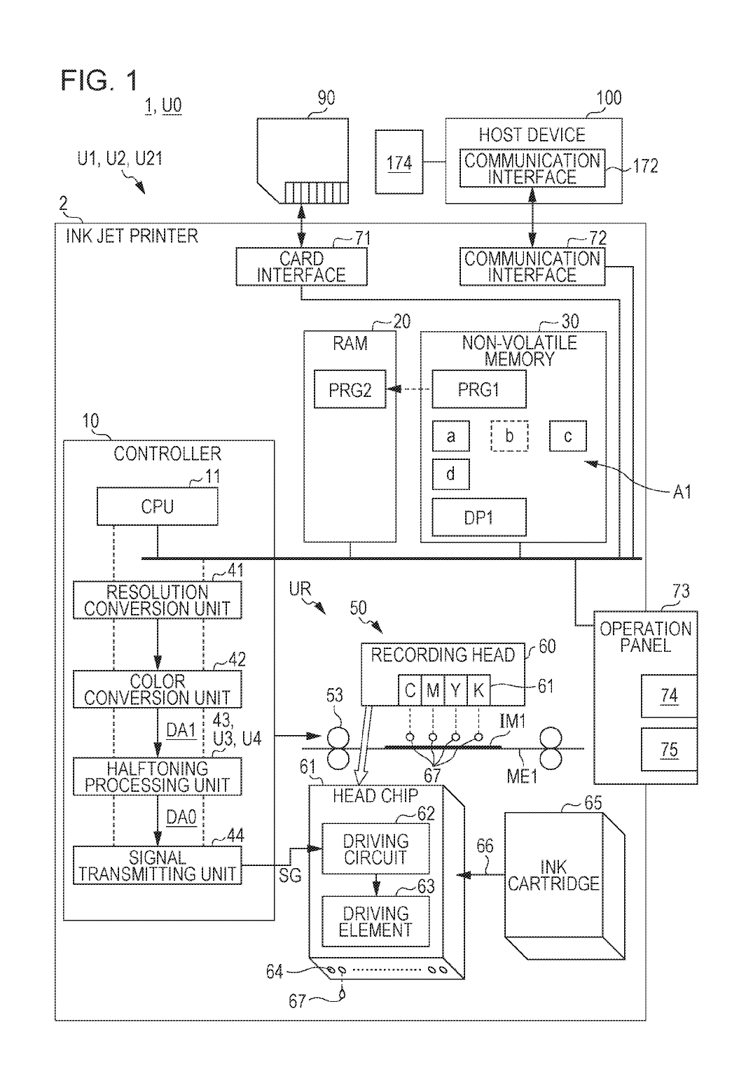

First, an outline of technology included in the invention will be described with reference to examples illustrated in FIGS. 1 to 13. In addition, diagrams in the application are diagrams which schematically illustrate an example, there is a case in which a magnification ratio in each direction which is illustrated in the diagram is different, and each diagram is not aligned. As a matter of course, each element of the technology is not limited to a specific example which is denoted by a reference numeral.

### First Aspect

An image processing device U0 according to one aspect of the technology is provided with a predetermined inclination correction amount obtaining unit U1, an inclination angle obtaining unit U2, and a recording data generating unit U3, and generates recording data DA0 for causing a recording head 60 which includes an overlapping portion 212 in which a part of nozzles 64 of a first nozzle column NL1 and a second nozzle column NL2 are overlapped in an aligning direction D1 of the nozzles 64 of a nozzle column 68 to eject liquid droplets (for example, ink droplets 67). The predetermined inclination correction amount obtaining unit U1 obtains a predetermined inclination correction amount A1 for correcting recording density which is changed when the recording head 60 is inclined by a predetermined angle α from a reference position P1 with respect to recording density of the liquid droplets (67) using the nozzles 64 of the overlapping portion 212. The inclination angle obtaining unit U2 obtains an inclination angle β of the recording head 60 from the reference position P1. The recording data generating unit U3 generates the recording data DA0 so that the recording density of the liquid droplets (67) using the nozzles 64 of the overlapping portion 212 is corrected, based on the predetermined inclination correction amount A1, and the inclination angle β of the recording head 60.

In the first aspect, recording density of the liquid droplets (67) using the nozzles 64 of the overlapping portion 212 is corrected based on the predetermined inclination correction amount A1 for correcting recording density which is changed when the recording head 60 is inclined by the predetermined angle α from the reference position P1 with respect to the recording density of the liquid droplets (67) using the nozzles 64 of the overlapping portion 212, and the inclination angle β of the recording head 60 from the reference position P1. In this manner, it is possible to suppress density unevenness in a non-overlapping region 221 and an overlapping region 222. Accordingly, in the aspect, it is possible to provide an image processing device which can suppress banding which occurs in the overlapping region.

Here, a nozzle is a small hole from which liquid droplets as ink droplets are ejected. In the ink droplets, non-colored ink, or the like, as ink droplets which improve an image quality is also included.

Recording density (referred to as RD) means a ratio of the number of dots which is formed by liquid droplets to a predetermined numbers of pixels, and means a ratio when being calculated into a largest dot (for example, large dot), when dots of different sizes are formed. A pixel is a minimum element which configures an image, and can assign a color, independently. For example, in a case in which large dots of Nd are formed with respect to 100 pixels, recording density RD becomes Nd %.

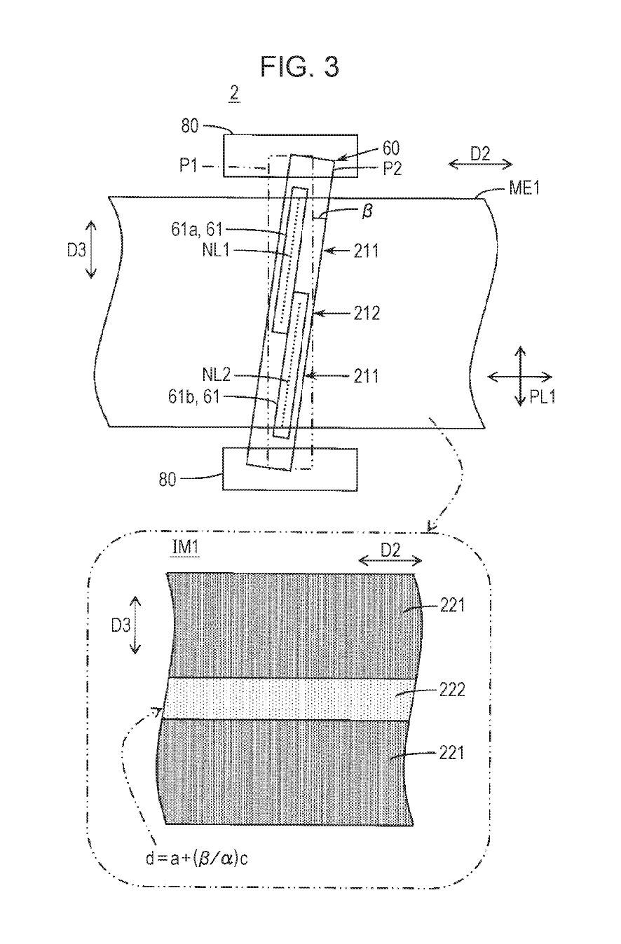

The above described additional remarks in the first aspect are similarly applied to the following aspects. Second Aspect (exemplified in FIG. 3, or the like)

The recording head 60 and a matter for recording (for example, matter for printing ME 1) may perform a relative movement in a relative movement direction D2 which intersects the aligning direction D1. The predetermined inclination correction amount obtaining unit U1 may obtain the predetermined inclination correction amount A1 for correcting recording density which is changed when the recording head 60 is inclined by the predetermined angle α from the reference position P1 in a virtual plane PL1 including the aligning direction D1 and the relative movement direction D2. The inclination angle obtaining unit U2 may obtain the inclination angle β of the recording head 60 from the reference position P1 in the virtual plane PL1. According to the aspect, it is possible to provide a preferable technology in which banding which occurs in an overlapping region can be suppressed.

Here, in the relative movement of the recording head and the matter for printing, a movement of the matter for printing without a movement of the recording head, and a movement of the recording head without a movement of the matter for printing, and movements of both of the recording head and the matter for printing are included.

Additional remarks of the second aspect are similarly applied to the following aspects.

Though it is not included in the second aspect, since the same operation and effects are exerted also in cases in which the predetermined angle is an angle in a plane which is deviated from the above described virtual plane, and the inclined angle of the recording head is an angle in the plane which is deviated from the virtual plane, the cases are included in the technology.

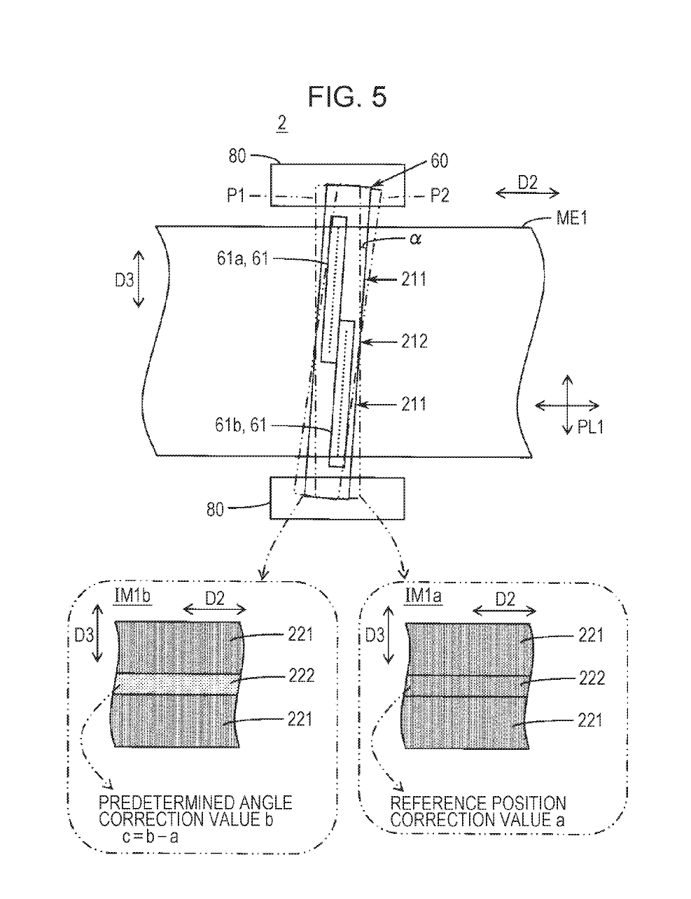

### Third Aspect (Exemplified in FIG. 5, or the Like)

The predetermined inclination correction amount obtaining unit U1 may obtain the predetermined inclination correction amount A1 based on a reference position correction value a for correcting recording density of the liquid droplets (67) using the nozzles 64 of the overlapping portion 212 in a case in which the recording head 60 is located at the reference position P1, and a predetermined angle correction value b for correcting recording density of the liquid droplets (67) using the nozzles 64 of the overlapping portion 212 in a case in which the recording head 60 is inclined by the predetermined angle α from the reference position P1. According to the aspect, it is possible to provide a preferable technology in which banding which occurs in an overlapping region is suppressed.

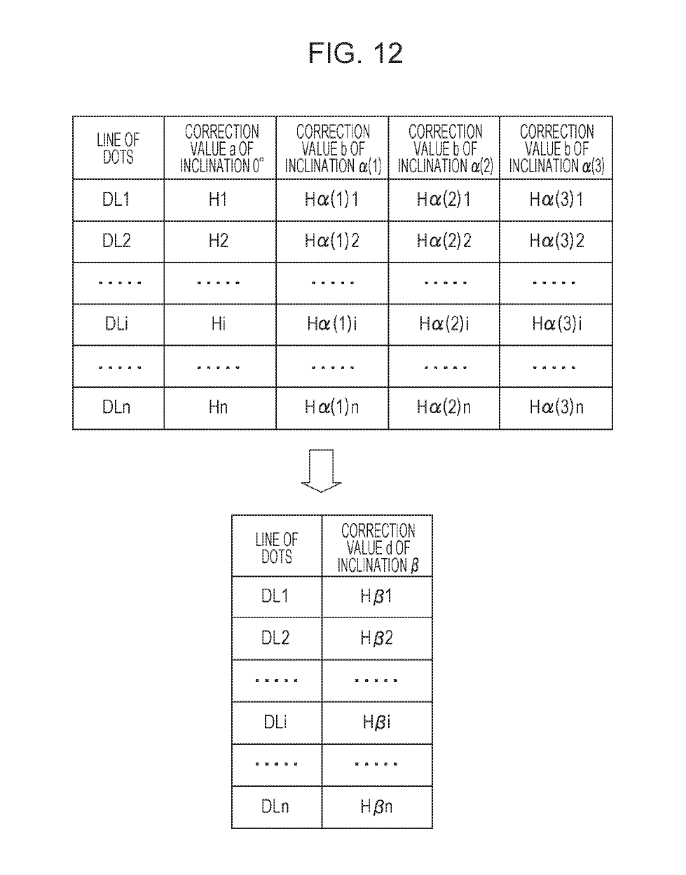

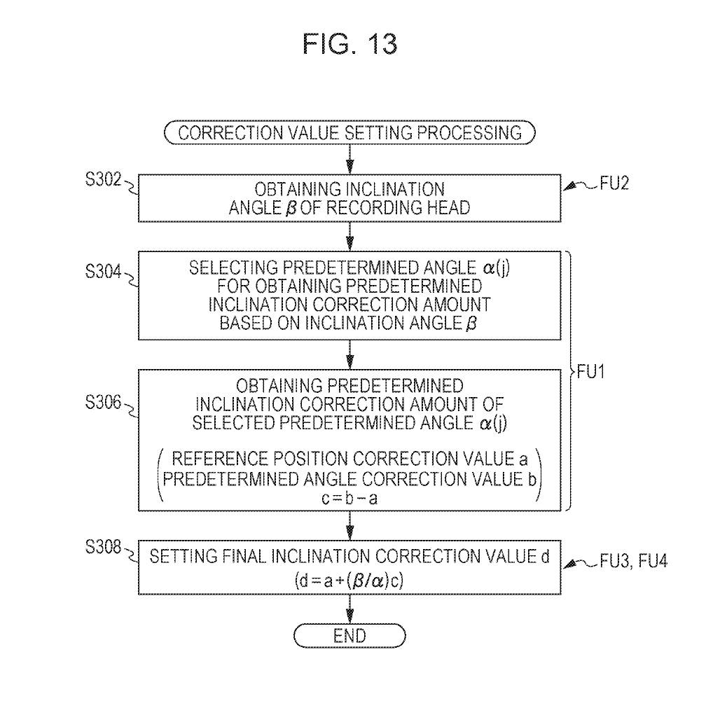

### Fourth Aspect (Exemplified in FIGS. 12 and 13)

The predetermined angle α may be formed in a plurality of stages. The image processing device U0 may be provided with a predetermined inclination correction amount storage unit (for example, non-volatile memory 30) which stores the predetermined inclination correction amount A1 with respect to each of the predetermined angles α of the plurality of stages. The predetermined inclination correction amount obtaining unit U1 may obtain the one or more predetermined inclination correction amount A1 from the predetermined inclination correction amount storage unit (30) based on the inclination angle β of the recording head 60. The recording data generating unit U3 may generate the recording data DA0 so that recording density of the liquid droplets (67) using the nozzles 64 of the overlapping portion 212 is corrected based on the above described one or more predetermined inclination correction amounts A1, and the inclination angle β of the recording head 60. According to the aspect, since recording density of the liquid droplets (67) using the nozzles 64 of the overlapping portion 212 is delicately corrected according to the inclination angle β of the recording head 60, it is possible to provide a technology in which banding which occurs in an overlapping region can be suppressed.

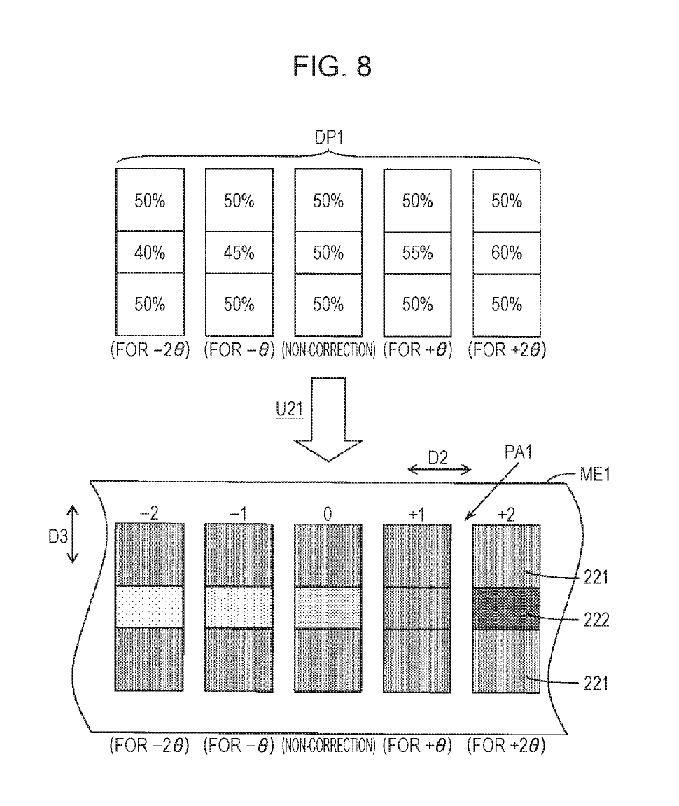

### Fifth Aspect (Exemplified in FIG. 8)

The inclination angle obtaining unit U2 may include a pattern output unit U21 which causes a printing apparatus 1 to form a plurality of inclination angle detecting patterns PA1 in which at least one of recording density of the liquid droplets (67) using the nozzles 64 of the overlapping portion 212 and recording density of the liquid droplets (67) using the nozzles 64 of the non-overlapping portion 211 in which the first nozzle column N11 and the second nozzle column NL2 are not overlapped is changed, by causing thereof to correspond to the inclination angle β of the recording head 60 from the reference position P1. The inclination angle obtaining unit U2 may obtain the inclination angle β of the recording head 60 by receiving an input of the inclination angle β of the recording head 60. According to the aspect, it is possible to provide a preferable example in which an inclination angle of the recording head is obtained.

Here, in receiving of the input of the inclination angle β, receiving of an operation of inputting the inclination angle β from a user, receiving of an input of an inclination angle β which is automatically determined by reading the plurality of inclination angle detecting patterns PA1 using an image reading apparatus, and the like, are included.

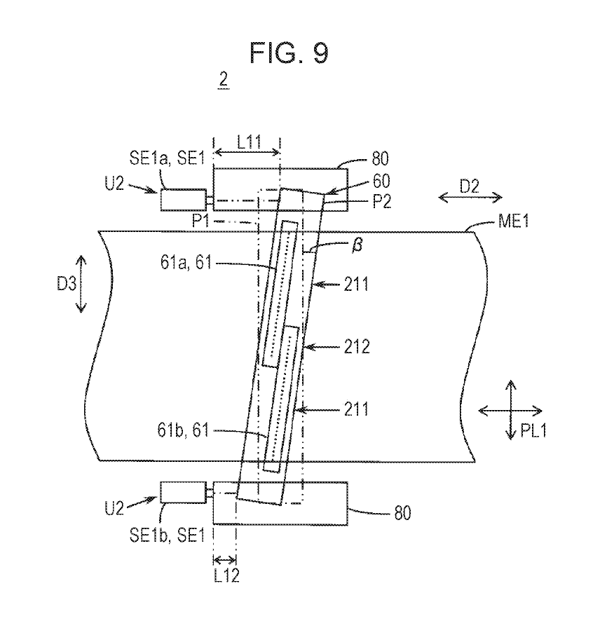

### Sixth Aspect (Exemplified in FIG. 9)

The inclination angle obtaining unit U2 may include a sensor SE1 for detecting the inclination angle β of the recording head 60 from the reference position P1. The inclination angle obtaining unit U2 may obtain the inclination angle β of the recording head 60 which is before being detected. According to the aspect, it is also possible to provide a preferable example in which an inclination angle of the recording head is obtained.

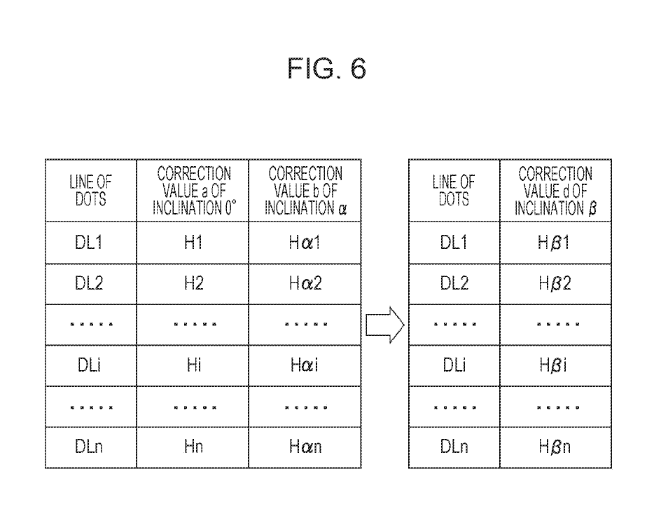

### Seventh Aspect (Exemplified in FIG. 6, or the Like)

A dot DT0 may be formed in the matter for recording (ME1) using the liquid droplets (67) from the recording head 60. The recording data generating unit U3 may correct recording density of the liquid droplets (67) using the nozzles 64 of the recording head 60 in a unit of line DL of the dot DT0 which is formed along the relative movement direction D2. According to the aspect, it is possible to provide a preferable example in which recording density of liquid droplets using nozzles of the recording head is corrected.

Though it is not included in the second aspect, correcting of recording density of liquid droplets using nozzles of the recording head, by putting together a plurality of lines, is included in the technology.

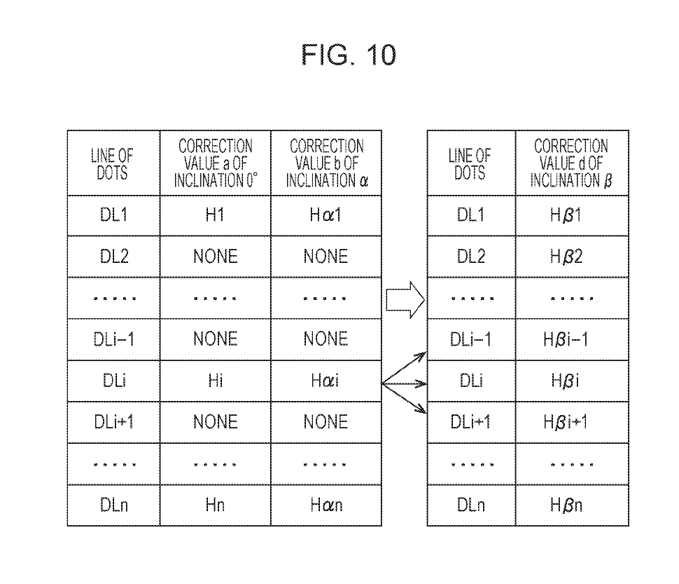

### Eighth Aspect (Exemplified in FIG. 10)

The predetermined inclination correction amount obtaining unit U1 may obtain the predetermined inclination correction amount A1 by putting a plurality of the lines DL together. Since a work of obtaining the predetermined inclination correction amount is reduced in the aspect, it is possible to provide a further preferable example in which recording density of liquid droplets using nozzles of the recording head is corrected.

### Ninth Aspect

An image processing program according to one aspect of the technology may cause a computer to execute a predetermined inclination correction amount obtaining function FU1 corresponding to the predetermined inclination correction amount obtaining unit U1, an inclination angle obtaining function FU2 corresponding to the inclination angle obtaining unit U2, and a recording data generating function FU3 corresponding to the recording data generating unit U3. According to the aspect, it is possible to provide an image processing program which can suppress banding which occurs in an overlapping region. In the image processing program, a pattern output function FU21 corresponding to the pattern output unit U21 may be caused to be executed by the computer.

### Tenth Aspect

A printing apparatus 1 according to one aspect of the technology is provided with the recording head 60 including the overlapping portion 212 in which nozzles 64 of the first nozzle column NL1 and the second nozzle column NL2 are partially overlapped in the aligning direction D1 of the nozzles 64 of the nozzle column 68, the predetermined inclination correction amount obtaining unit U1, the inclination angle obtaining unit U2, and a recording density correcting unit U4. The predetermined inclination correction amount obtaining unit U1 obtains the predetermined inclination correction amount A1 for correcting recording density which is changed when the recording head 60 is inclined by a predetermined angle α from the reference position P1, with respect to recording density of the liquid droplets 67 which are ejected from the nozzles 64 of the overlapping portion 212. The inclination angle obtaining unit U2 obtains the inclination angle β of the recording head 60 from the reference position P1. The recording density correcting unit U4 corrects recording density of the ink droplets 67 using the nozzles 64 of the overlapping portion 212, based on the predetermined inclination correction amount A1 and the inclination angle β of the recording head 60.

According to the tenth aspect, recording density of the liquid droplets 67 using the nozzles 64 of the overlapping portion 212 is corrected, based on the predetermined inclination correction amount A1 for correcting recording density which is changed when the recording head 60 is inclined by the predetermined angle α from the reference position P1, with respect to the recording density of the liquid droplets 67 using the nozzles 64 of the overlapping portion 212, and the inclination angle β of the recording head 60 from the reference position P1. In this manner, it is possible to suppress density unevenness of the non-overlapping region 221 and the overlapping region 222. Therefore, according to the aspect, it is possible to provide a printing apparatus which can suppress banding which occurs in the overlapping region.

In addition, the technology can be applied to a composite device including the image processing device, a composite device including the printing apparatus, a control method of the image processing device, a control method of the printing apparatus, a control method of the composite device, a control program of the printing apparatus, a control program of the composite device, a computer-readable medium in which the image processing program or the control program is recorded, or the like. The above described devices may be configured of a plurality of portions which are distributed.

### (2) Specific Example of Printing Apparatus which Includes Image Processing Device

FIG. 1 schematically illustrates a configuration example of the printing apparatus which includes the image processing device. The printing apparatus 1 illustrated in FIG. 1 is denoted as a printing system (printing apparatus in broad sense) which includes constituent elements of the technology, includes at least the ink jet printer 2 in a narrow sense as a sales unit, and includes a host device 100, or the like. The image processing device U0 illustrated in FIG. 1 is included in the printing apparatus 1, both the ink jet printer 2 and the host device 100 may realize the image processing device U0, the ink jet printer 2 excluding the host device 100 may realize the image processing device U0, and the host device 100 excluding the ink jet printer 2 may realize the image processing device U0. In FIG. 1, a configuration example of a line printer as the ink jet printer 2 is also illustrated. A printing apparatus to which the technology can be applied may include a copier, a facsimile, a multifunction printer provided with these function, or the like. In ink which is used in an ink jet printer which forms a color image, for example, ink of C (cyan), M (magenta), Y (yellow), and K (black) are contained. As a matter of course, ink of Lc (light cyan), Lm (light magenta), Dy (dark yellow), Lk (light black), Or (orange), Gr (green), non-colored ink for improving an image quality, or the like, may be included in the ink.

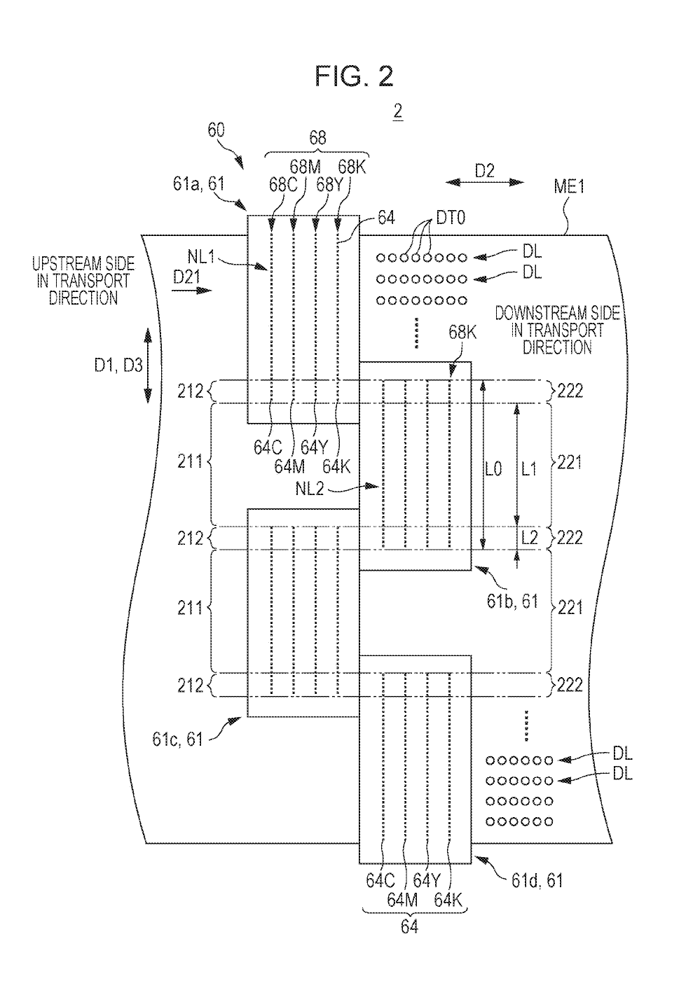

FIG. 2 schematically illustrates main portions of the line printer as the ink jet printer 2. The line printer includes a line head as the recording head 60 in which a plurality of head chips 61 are combined, and when forms a dot DT0 by ejecting ink droplets 67 (example of liquid droplets), the recording head 60 does not move, and the long matter for printing ME1 (example of matter for recording) moves. The matter for printing (print substrate) is a material for holding a printed image, and includes at least all of kinds of paper, paper board, and a processed product which are described in JIS (Japan Industrial Standards) P0001:1998 (terminology of paper, paper board, and pulp). A resin sheet, a metal plate, a three-dimensional object, and the like, are also included in the matter for printing.

In FIG. 2, the reference numeral D1 denotes the aligning direction of the nozzle 64, the reference numeral D2 denotes a relative movement direction of the recording head 60 and the matter for printing ME1, the reference numeral D21 denotes a sheet sending direction, and the reference numeral D3 denotes a width direction of the long matter for printing ME1. When the matter for printing ME1 moves from an upstream side in the transport direction to a downstream side in the transport direction with respect to the recording head 60 which is fixed, the dots DT0 are formed in order from the upstream side in the transport direction to the upstream side in the transport direction on the matter for printing ME1. In the example in FIG. 2, the aligning direction D1 and the width direction D3 match with each other; however, the directions may be shifted, for example, the aligning direction D1 and the width direction D3 may be approximately shifted by 45°, or the like. These directions D1, D3, and the sheet sending direction D21 (relative movement direction D2) may be different directions, and a case of intersecting, without being orthogonal, such as intersecting at an angle of approximately 45° is also included in the invention, not only being orthogonal to each other. As a matter of course, intersecting of two directions means that two directions are shifted, including being orthogonal to each other. The recording head 60 and the dot DT0 illustrated in FIG. 2 are schematically illustrated only for descriptions, and an actual size, shape, the number, and the like, thereof are not limited to those in the figure. For example, the number of head chips 61 included in the recording head 60 is not limited to four which is illustrated in FIG. 2, may be three or less, or five or more.

The recording head 60 illustrated in FIG. 2 includes a plurality of head chips 61 which include a nozzle column 68C of C, a nozzle column 68M of M, a nozzle column 68Y of Y, and a nozzle column 68K of K. The head chips 61 may be provided in each color of CMYK. Each of nozzle columns 68C, 68M, 68Y, and 68K is aligned in the relative movement direction D2. In each of nozzle columns 68C, 68M, 68Y, and 68K, nozzles 64C, 64M, 64Y, and 64K are aligned in the aligning direction D1. In the recording head 60, a plurality of head chips 61a to 61d are disposed so that it is possible to form the dot DT0 on the matter for printing ME1 using the liquid droplets 67 which are ejected from the nozzles 64C, 64M, 64Y, and 64K, over the entire width direction D3 of the matter for printing ME1. Here, the head chips 61a to 61d are collectively referred to as the head chip 61, the nozzle columns 68C, 68M, 68Y, and 68K are collectively referred to as the nozzle column 68, and the nozzles 64C, 64M, 64Y, and 64K are collectively referred to as the nozzle 64.

The recording head 60 includes the plurality of nozzle columns 68 in which the plurality of nozzles 64 are aligned in the aligning direction D1 which is different from the relative movement direction D2. The nozzle column 68 here means any one of the nozzle columns CYMK. In the meaning, as illustrated in FIG. 2, nozzles 64 of the first nozzle column NL1 and the second nozzle column NL2 which are included in the plurality of nozzle columns 68 are partially overlapped in the aligning direction D1. For example, when applying the nozzle column of K of the head chip 61a to the first nozzle column NL1, the nozzle column of K of the head chip 61b which is adjacent to the head chip 61a corresponds to the second nozzle column NL2 in the width direction D3. As a matter of course, since the first nozzle column NL1 and the second nozzle column NL2 are relatively determined, a nozzle column of the head chip 61c may be applied to the first nozzle column NL1, and a nozzle column of the head chip 61d may be applied to the second nozzle column NL2.

Here, a length of the nozzle column 68 in the aligning direction D1 is set to L0, a length of the overlapping portion 212 in the aligning direction D1, of which positions in the aligning direction D1 are overlapped in the nozzles 64 of adjacent head chips is set to L2, and a length of the non-overlapping portion 211 in the aligning direction D1, of which positions in the aligning direction D1 are not overlapped in the nozzles 64 of adjacent head chips is set to length L1. The length L0 of the nozzle columns of the head chips 61b and 61c becomes L1+2×L2. The overlapping region 222 in which dots are formed by nozzles of adjacent head chips, and the non-overlapping region 221 in which dots are formed by nozzles in one of adjacent head chips are generated in the matter for printing ME1. In addition, the “OL” illustrated in FIG. 2 denotes “overlapping”, and the overlapping portion is also referred to as a connection portion.

In addition, even when it is a nozzle column in which nozzles are disposed in zigzag, the plurality of nozzles are aligned in two columns, for example, in a predetermined aligning direction which is different from the relative movement direction, and the nozzle column is included in the technology. The aligning direction in this case means the aligning direction of nozzles in each column in the zigzag disposal.

FIG. 2 illustrates a state in which a line DL of the dots DT0 which are formed along the relative movement direction D2 are formed on the matter for printing ME1 using the liquid droplets 67 from the recording head 60. As will be described later, in the specific example, recording density of the liquid droplets 67 using the nozzles 64 of the recording head 60 is corrected in a unit of the line DL.

FIG. 3 schematically illustrates an example in which the recording head which is attached to the ink jet printer is inclined. In FIG. 3, the inclination angle β of the recording head 60 which is located at the position P2 which is inclined from the reference position P1 (denoted by two dot-dashed line) in the virtual plane PL1 which includes the aligning direction D1 and the relative movement direction D2 is denoted by being exaggerated. The virtual plane PL1 is a virtual plane which goes along a paper plane in FIG. 3. In FIG. 3, for ease of, illustration, the ink jet printer 2 is schematically illustrated by setting the number of head chips 61 which are included in the recording head 60 to two, and setting the nozzle columns NL1 and NL2 to columns of the nozzle 64 which ejects ink of any colors (for example, any one color of C, M, Y, and K).

The ink jet printer 2 illustrated in FIG. 3 includes an attaching portion 80 of the recording head 60, and the recording head 60 is attached to the attaching portion 80. The reference position P1 to which the recording head 60 is attached is a position with an inclination of zero in design. However, when the recording head 60 is attached to the ink jet printer 2, there is a slight inclination. Due to this, recording density in the overlapping region 222 becomes high or low when recording density in the non-overlapping region 221 is set to a reference. An example in which light stripes occur in the overlapping region 222 of a printed image IM1 due to the low recording density in the overlapping region 222 is illustrated on the lower part in FIG. 3. Though it is not illustrated, when recording density in the overlapping region 222 becomes high, dark stripes occur in the overlapping region 222 of the printed image IM1.

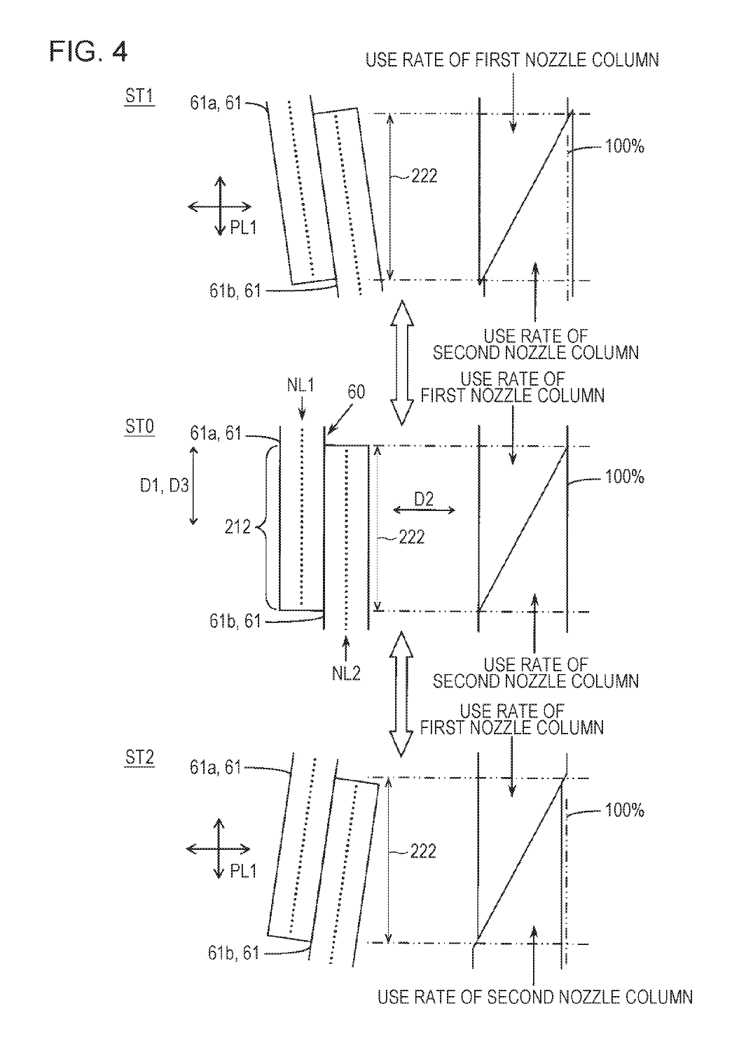

FIG. 4 schematically illustrates an example in which recording density in the overlapping region is changed according to an inclination of the recording head. In the middle stage in FIG. 4, use rates of the first nozzle column NL1 and the second nozzle column NL2 of the overlapping region 222 in a state ST0 of the inclination angle β of the recording head 60 is zero are denoted. In the overlapping portion 212 of the nozzle columns NL1 and NL2, a use rate of the first nozzle column NL1 is lowered from 100% to 0% when it goes toward the second nozzle column NL2 side, and a use rate of the second nozzle column NL2 is lowered from 100% to 0% when it goes toward the first nozzle column NL1 side. As a matter of course, the use rates of the nozzle columns NL1 and NL2 becomes 100% when being added.

Here, as illustrated in the upper stage in FIG. 4, the recording head 60 is inclined in the left direction in the virtual plane PL1 which includes the aligning direction D1 and the relative movement direction D2 (state ST1). In this case, the overlapping portion 212 is expanded in the width direction D3, and due to this, the use rates of the nozzle columns NL1 and NL2 exceed 100% when being added. Accordingly, recording density in the overlapping region 222 becomes high, and dark stripes occur in the overlapping region 222 of the printed image IM1.

In addition, as illustrated in the lower stage in FIG. 4, the recording head 60 is inclined in the right direction in the virtual plane PL1 (state ST2). In this case, the overlapping portion 212 becomes narrow in the width direction D3, and due to this, the use rates of the nozzle columns NL1 and NL2 lower 100% when being added. Accordingly, recording density in the overlapping region 222 becomes low, and light stripes occur in the overlapping region 222 of the printed image IM1.

Therefore, in the specific example, the predetermined inclination correction amount A1 (for example, values a, b, c) for correcting recording density which is changed when the recording head 60 is inclined by the predetermined angle α from the reference position P1, with respect to recording density of the liquid droplets 67 using the nozzles 64 of the overlapping portion 212, is obtained, the inclination angle β of the recording head 60 from the reference position P1 is obtained, and recording density of the liquid droplets 67 using the nozzles 64 of the overlapping portion 212 is corrected. In the specific example, a half toning processing unit 43 illustrated in FIG. 1 will be described as an example of the recording data generating unit U3 and the recording density correcting unit U4. As a matter of course, since correcting of recording density may be performed in any stages, a color conversion unit 42 may become the recording data generating unit U3 and the recording density correcting unit U4, or a signal transmitting unit 44 may become the recording data generating unit U3 and the recording density correcting unit U4.

First, a configuration of the printing apparatus 1 which is illustrated in FIG. 1 will be described. The ink jet printer 2 illustrated in FIG. 1 is provide with a controller 10, a random access memory (RAM) 20, a non-volatile memory 30 (example of predetermined inclination correction amount storage unit), a mechanism unit 50, interfaces (I/F) 71 and 72, an operation panel 73, and the like. The controller 10, the RAM 20, the non-volatile memory 30, the interfaces (I/F) 71 and 72, and the operation panel 73 can input or output information each other.

The controller 10 is provided with a central processing unit (CPU) 11, a resolution conversion unit 41, the color conversion unit 42 the halftoning processing unit 43, the signal transmitting unit 44, and the like. In addition, at least a part of functions of these processing units (41 to 44) may be executed by the host device 100. The controller 10 can be configured of a system on a chip (SoC), or the like.

The CPU 11 is a device which mainly performs information processing or a control in the ink jet printer 2.

The resolution conversion unit 41 converts a resolution of an image which is input from the host device 100, a memory card 90, or the like, into a printing resolution (for example, 720×720 dpi or 360×360 dpi). The above described input image is expressed, for example, by RGB data which includes integer values of 256 grayscales of RGB in each pixel. When the input image is not the RGB data, the input image may be converted into the RGB data.

The color conversion unit 42 converts, for example, the RGB data which is set to the printing resolution into CMYK data (example of image data DA1 before being corrected) including integer values of 256 grayscales of CMYK (cyan, magenta, yellow, and black) in each pixel.

The halftoning processing unit 43 (example of recording data generating unit U3 and recording density correcting unit U4) firstly corrects the CMYK data based on the predetermined inclination correction amount A1 and the inclination angle β. After that, the halftoning processing unit 43 reduces the number of grayscales of grayscale values by performing predetermined halftoning processing such as a dither method, an error diffusion method, or a density pattern method with respect to a grayscale value of each pixel which configures the CMYK data, and generates recording data DA0. The recording data DA0 is data which denotes a forming situation of dots of each pixel corresponding to the printed image IM1, and for example, can be set to binary data which denotes whether or not dots of each pixel is formed. In addition, the recording data DA0 may be multivalued data of three grayscales or more which can correspond to dots of different sizes, such as four-valued data in which zero is caused to correspond to no dot, one is caused to correspond to forming of a small dot, two is caused to correspond to forming of a medium dot, and three is caused to correspond to forming of a large dot.

The signal transmitting unit 44 generates a driving signal SG corresponding to a voltage signal which is applied to a driving element 63 of the head chip 61 based on the recording data DA0, and outputs the signal to a driving circuit 62. The recording data DA0 may be rearranged in order of forming of dots in the mechanism unit 50, as necessary.

The above described each unit 41 to 44 may be configured of an application specific integrated circuit (ASIC), may directly read data of a processing target from the RAM 20, or may directly write processed data in the RAM 20.

The mechanism unit 50 which is controlled by the controller 10 is provided with the paper sending mechanism 53, or the like. The paper sending mechanism 53 sends the matter for printing ME1 in the paper sending direction D21. The head chip 61 which ejects the liquid droplets 67 of CMYK, for example, is mounted on the recording head 60. The head chip 61 is provided with the driving circuit 62, the driving element 63, or the like. The driving circuit 62 applies a voltage signal to the driving element 63 according to the driving signal SG which is input from the controller 10. It is possible to use a piezoelectric element which applies a pressure to ink 66 (example of liquid) in a pressure chamber which communicates with the nozzle 64, a driving element which causes the ink droplets 67 to be ejected from the nozzle 64 by generating air bubbles in the pressure chamber using heat, or the like, in the driving element 63. The ink 66 is supplied from an ink cartridge 65 (example of liquid cartridge) to the pressure chamber of the head chip 61. A combination of the ink cartridge 65 and the head chip 61 is provided in each of CMYK, for example. The ink 66 in the pressure chamber is ejected as the ink droplets 67 from the nozzle 64 toward the matter for printing ME1 by the driving element 63, and the dot DT0 of the ink droplets 67 is formed on the matter for printing ME1 such as a printing sheet, or the like. The printed image IM1 using the plurality of dots DT0 is formed on the matter for printing ME1.

A program PRG2 which causes the printing apparatus 1 to execute the function of the predetermined inclination correction amount obtaining unit U1 or the inclination angle obtaining unit U2 is stored in the RAM 20.

Pattern data DP1 for outputting program data PRG1 which is developed in the RAM 20, the predetermined inclination correction amount A1, and the inclination angle detecting pattern PA1 which is illustrated in FIG. 8, and the like, are stored in the non-volatile memory 30 (example of predetermined inclination correction amount storage unit). The predetermined inclination correction amount A1 includes at least a part of a reference position correction value a, a predetermined angle correction value b, and a differential value c=b−a. A magnetic recording medium, or the like, such as a read only memory (ROM), a flash memory, and a hard disk are used in the non-volatile memory 30. In addition, developing of the program data PRG1 means that the program data PRG1 is written in the RAM 20 as a program PRG2 which can be interpreted in the CPU 11.

The card I/F 71 is a circuit which writes data in the memory card 90, or reads data from the memory card 90.

The communication I/F 72 is connected to a communication I/F 172 of the host device 100, and inputs or outputs information with respect to the host device 100. A display device 174, or the like, may be connected to the host device 100. A computer such as a personal computer (including tablet computer), a digital camera, a digital video camera, a mobile phone such as a smart phone, and the like, are included in the host device 100.

The operation panel 73 includes an output unit 74, an input unit 75, and the like, and in which a user can input various instruction to the ink jet printer 2. The output unit 74 is configured of, for example, a liquid crystal panel (display unit) on which information corresponding to various instructions or information denoting a state of the ink jet printer 2 is displayed. The output unit 74 may output the information using a sound. The input unit 75 is configured of, for example, an operation key (operation input unit) such as a curser key, or a determination key. The input unit 75 may be a touch panel, or the like, which receives an operation with respect to a display screen.

In addition, the mechanism unit 50 including the paper sending mechanism 53, and the head chip 61 are referred to as a printing unit UR.

FIG. 5 schematically illustrates an example of obtaining the predetermined inclination correction amount A1. The predetermined inclination correction amount A1 is a correction amount for correcting recording density which is changed when the recording head 60 is inclined by the predetermined angle α from the reference position P1 with respect to the recording density of the liquid droplets 67 using the nozzles 64 of the overlapping portion 212. The predetermined angle α is an angle which is inclined from the reference position P1 of the recording head 60 in the virtual plane PL1 which includes the aligning direction D1 and the relative movement direction D2.

The lower right part in FIG. 5 illustrates a printed image IM1a which is formed when the recording head 60 is strictly attached to the reference position P1 with no inclination. As will be described later, recording density of the liquid droplets 67 using the nozzles 64 of the recording head 60 is corrected in a unit of the line DL of the dot DT0. Here, a correction value for correcting recording density of the overlapping region 222 of the printed image IM1a is referred to as a reference position correction value a.

The reference position correction value a can be set as follows, for example.

First, the printed image IM1a with predetermined recording density, for example, recording density of 50%, or the like, is formed on the matter for printing ME1, density is measured, using a densitometer, with respect to all of the line DLs which includes both of the non-overlapping region 221 and the overlapping region 222, and average density (set to AC1) of the measured density is obtained. Subsequently, the reference position correction value a is determined so that the measured density of a focused line (set to Cli) matches the average density AC1 of all of lines. Here, the variable i is a variable for identifying the line DL. For example, the reference position correction value a can be set to a ratio of the differential value AC1-Cli (AC1-Cli)/AC1 to the average density AC1. Finally, the reference position correction value a which is determined in each line is caused to be stored in the non-volatile memory 30.

A lower left part in FIG. 5 illustrates a printed image IM1b which is formed in a case in which the recording head 60 is attached by being inclined by the predetermined angle α from the reference position P1. A correction value for correcting recording density in the overlapping region 222 of the printed image IM1b is referred to as the predetermined angle correction value b.

The predetermined angle correction value b can be set as follows, for example.

First, the printed image IM1b with the same recording density as that of the printed image IM1a is formed on the matter for printing ME1, density is measured, using a densitometer, with respect to all of the line DLs which includes both of the non-overlapping region 221 and the overlapping region 222, and average density (set to AC2) of the measured density is obtained. Subsequently, the predetermined angle correction value b is determined so that the measured density of a focused line (set to C2i) matches the average density AC2 of all of lines. For example, the predetermined angle correction value b can be set to a ratio of a differential value AC2-C2i (AC2-C2i)/AC2 to the average density AC2. The predetermined angle correction value b which is determined in each line is caused to be stored in the non-volatile memory 30, as necessary.

When there are the above described correction values a, b, and the actual inclination angle β of the recording head 60, it is possible to calculate a final inclination correction value b for correcting recording density of the ink droplets 67 using nozzles of the overlapping portion 212, by using the following expression, for example.

d=a+(β/α)(b−a) (1)

For example, in a case in which the predetermined angle α is 1°, and the inclination angle β of the recording head is 2°, it becomes the above described expression (1) becomes d=a+2(b−a). In this manner, when the correction values a and b are obtained as the predetermined inclination correction amount A1, it is possible to correct the recording density of the ink droplets 67 using the nozzles of the overlapping portion 212 according to the inclination angle β of the recording head 60.

It is possible to calculate a final inclination correction value d, even when obtaining the reference position correction value a and the differential value c=b−a, as the predetermined inclination correction amount A1.

d=a+(β/α)c (2)

Accordingly, the differential value c=b−a is determined in each line, and the differential value may be stored in the non-volatile memory 30 instead of the predetermined angle correction value b, or along with the predetermined angle correction value b.

In addition, a coefficient of the differential value c may be a function f (β/α) which is obtained by slightly shifting an angle ratio β/α, not the angle ratio β/α as is.

d=a+f(β/α)×c (3)

FIG. 6 schematically illustrates an example of obtaining a final inclination correction value in a unit of a line of the dot. Here, each line is denoted by a line DLi using the variable i (i=1, 2, . . . , n, n is integer of 2 or more) which identifies the line DL of the dot DT0, and the reference position correction value a in a case of an inclination of 0° is denoted by a correction value Hi and the predetermined angle correction value b in a case of predetermined angle α is denoted by a correction value Hαi. For example, the correction values Hi and Hαi of each line DLi are set to be stored in the non-volatile memory 30. Each line DLi illustrated in FIG. 6 is set to a line in the overlapping region 222; however, the line DLi may include a line in the non-overlapping region 221. When the final inclination correction value d in a case of the inclination angle β is obtained based on the correction values Hi and Hαi of each line DLi, and the inclination correction value d in the line DLi is denoted by a correction value Hβi, the correction value Hβi in each line Dli can be calculated, using the following expression.

Hβi=Hi+(β/α)(Hαi−Hi) (4)

As a matter of course, when the differential value c in each line Dli is denoted by a differential value ΔHi, it is possible to calculate the correction value Hβi in each line Dli using the following expression.

Hβi=Hi+(β/α)ΔHi (5)

For example, the differential value ΔHi of each line DLi is set to be stored in the non-volatile memory 30 instead of the correction value Hαi, or along with the correction value Hαi.

In addition, the function f (β/α) which is obtained by slightly shifting the angle ratio β/α may be used in the coefficient of the differential value ΔHi.

Hβi=Hi+f(β/α)×ΔHi (6)

### (3) Processing Example of Printing Apparatus Including Image Processing Device

Subsequently, an example of processing which is performed by the printing apparatus 1 will be described.

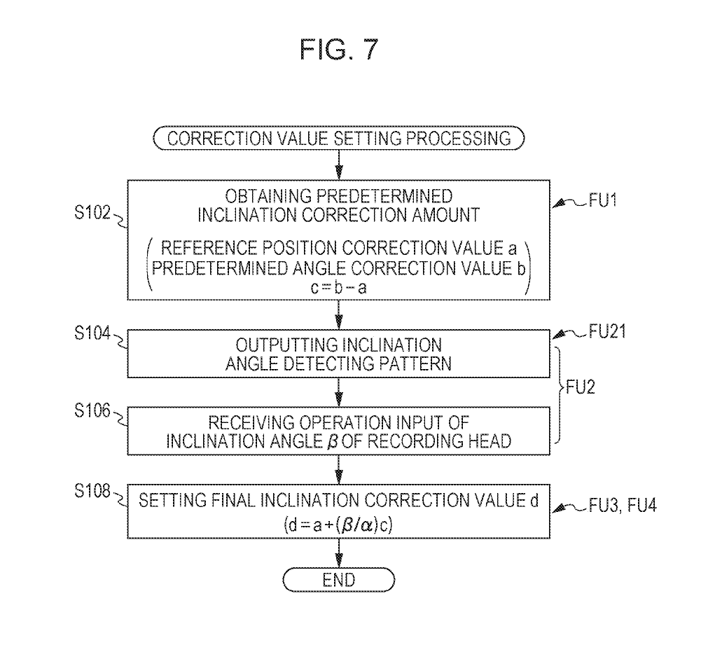

FIG. 7 illustrates an example of correction value setting processing which is performed by the image processing device U0. In the specific example, it is described that the ink jet printer 2 performs the correction value setting processing; however, the host device 100 may perform the correction value setting processing, or the ink jet printer 2 and the host device 100 may perform the correction value setting processing in cooperation. The image processing device can execute plurality of processing in parallel using multitasking. The correction value setting processing is started when a predetermined operation of setting the inclination correction value d is performed with respect to the operation panel 73 or the host device 100. Here, step S102 corresponds to the predetermined inclination correction amount obtaining unit U1 and the predetermined inclination correction amount obtaining function FU1. Steps S104 to S106 correspond to the inclination angle obtaining unit U2 and the inclination angle obtaining function FU2. Step S104 corresponds to the pattern output unit U21 and the patter output function FU21. Step S108 corresponds to the recording data generating unit U3, the recording density correcting unit U4, the recording data generating function FU3, and the recording density correcting function FU4. Hereinafter, descriptions of “step” will be omitted.

Processing according to the embodiment is not limited to the example executed by the CPU, and may be executed by another electronical component [for example, application specific integrated circuit (ASIC)]. In addition, processing according to the embodiment may be subjected to distributed processing by a plurality of CPUs, or may be executed by a cooperative operation of the CPU and the electronical component (for example, ASIC).

When the processing is started, the controller 10 of the ink jet printer 2 obtains the predetermined inclination correction amount A1 which includes at least one of the reference position correction value a, the predetermined angle correction value b, and the differential value c (S102). As described above, the predetermined inclination correction amount A1 is a correction amount for correcting recording density which is changed when the recording head 60 is inclined by the predetermined angle α from the reference position P1 in the virtual plane PL1. Since the predetermined inclination correction amount A1 is stored in the non-volatile memory 30, in S102, the predetermined inclination correction amount A1 is read by the RAM 20 from the non-volatile memory 30, for example. In a case in which the correction values Hi and Hαi in each line are stored in the non-volatile memory 30, the correction values Hi and Hαi in each line are read by the RAM 20. In a case in which the correction value ΔHi is stored in the non-volatile memory 30 in each line, the correction value ΔHi in each line is read by the RAM 20.

After obtaining the predetermined inclination correction amount A1, the controller 10 outputs the pattern data PD1 to the head chip 61 in order to form the plurality of inclination angle detecting patterns PA1 which are illustrated in FIG. 8 on the matter for printing ME1 (S104).

The plurality of inclination angle detecting patterns PA1 which are illustrated in FIG. 8 are patterns which changes recording density of ink droplets using the nozzles of the overlapping portion 212 by causing thereof to correspond to the inclination angle β of the recording head 60 from the reference position P1. For example, a difference in inclination angle β of the recording head 60 is set to correspond to a difference in recording density 5% of the overlapping region 222. In this case, a change in recording density of the overlapping region 222 corresponding to an inclination angle −2θ, −θ, 0, +θ, and +2θ of the recording head 60 becomes −10%, −5%, 0%, +5%, and +10%, respectively. In a case in which recording density of the non-overlapping region 221 and the overlapping region 222 at the inclination angle 0 is set to 50%, recording density of the overlapping region 222 corresponding to the inclination angle −2θ, −θ, 0, +0, and +2θ becomes 40%, 45%, 50%, 55%, and 60%, respectively. FIG. 8 illustrates a state in which the inclination angle detecting patterns PA1 of “−2”, “−1”, “0”, “+1”, and “+2” are respectively formed from pattern data DP1 for −2θ, −θ, no correction, +θ, and +2θ. As a matter of course, when there is no inclination in the recording head 60, recording density in the overlapping region 222 of the inclination angle detecting pattern of “−2”, “−1”, “0”, “+1”, and “+2” should become 40%, 45%, 50%, 55%, and 60%, respectively.

When the recording head 60 is inclined, there is a difference between recording density in the non-overlapping region 221 and recording density in the overlapping region 222 in the inclination angle detecting pattern “0”. For example, in a case in which the inclination angle of the recording head 60 is +0, as illustrated in FIG. 8, a difference between recording density in the non-overlapping region 221 and recording density in the overlapping region 222 becomes the smallest when the inclination angle detecting pattern is “+1”. Therefore, for example, when receiving a selecting operation of the inclination angle detecting pattern, it is possible to obtain the inclination angle β corresponding to the inclination angle detecting pattern which is subjected to the selecting operation.

In addition, even when recording density in the non-overlapping region 221 is changed instead of recording density in the overlapping region 222, it is possible to form the inclination angle detecting pattern PA1. For example, it is possible to set the recording density in the non-overlapping region 221 with the inclination angle detecting pattern of “−2”, “−1”, “0”, “+1”, and “+2” to 60%, 55%, 50%, 45%, and 40%, respectively, by fixing recording density in the overlapping region 222 to 50%. Also in this case, the inclination angle detecting pattern of “−2”, “−1”, “0”, “+1”, and “+2” corresponds to the inclination angle −2θ, −θ, 0, +0, and +2θ, respectively.

In addition, it is also possible to change recording density in the non-overlapping region 221 to 55%, 52.5%, 50%, 47.5%, and 45%, by changing recording density in the overlapping region 222 to 45%, 47.5%, 50%, 52.5%, and 55%. Also in this case, the inclination angle detecting pattern of “−2”, “−1”, “0”, “+1”, and “+2” corresponds to the inclination angle −2θ, −θ, 0, +0, and +20, respectively.

After outputting the inclination angle detecting pattern PA1, the controller 10 obtains the inclination angle β of the recording head 60 by receiving the operation input of the inclination angle β of the recording head 60 (S106). The processing in S106 can be set to processing for obtaining an inclination angle β corresponding to a number by receiving an input for operating the number of the inclination angle detecting pattern in the input unit 75 of the operation panel 73, for example. In addition, it may be configured so that the host device 100 obtains an inclination angle β corresponding to the number by receiving the operation input of the number of the inclination angle detecting pattern, and transmits the inclination angle β to the ink jet printer 2, and the ink jet printer 2 receives the inclination angle β. In addition, it may be configured so that an inclination angle detecting pattern PA1 with the smallest difference in recording density between the non-overlapping region 221 and the overlapping region 222 by reading a plurality of the inclination angle detecting patterns in using a scanner (example of image reading apparatus), and obtain an inclination angle β corresponding to the selected inclination angle detecting pattern. The obtained inclination angle β is an inclination angle of the recording head 60 from the reference position P1 in the virtual plane PL1.

In the example illustrated in FIG. 8, when inputting a number denoting the inclination angle detecting pattern “+1” to the operation panel 73, or the like, an inclination angle β=+θ which corresponds to the inclination angle detecting pattern “+1” is obtained.

In addition, as illustrated in FIG. 9, it may be configured so that the sensor SE1 for detecting an inclination angle β of the recording head 60 from the reference position P1 is provided in the ink jet printer 2, and the inclination angle β of the detected recording head 60 is obtained. It is possible to use distance sensors SE1a and SE1b for detecting distances L11 and L12 to the recording head 60, for example, in the sensor SE1. The distance sensor SE1a illustrated in FIG. 9 detects the distance L11 to the recording head 60 on one side in the width direction D3. The distance sensor SE1b illustrated in FIG. 9 detects the distance L12 to the recording head 60 on the other side in the width direction D3. When a corresponding relationship between a distance difference L11−L12 and the inclination angle β is obtained, it is possible to detect the inclination angle β corresponding to the distance difference L11−L12 by detecting the distance L11−L12 using the distance sensors SE1a and SE1b. This processing may be performed instead of the processing in S104 to S106 which are illustrated in FIG. 8.

As a matter of course, the processing of obtaining the inclination angle β using the inclination angle detecting pattern PA1, and the processing of obtaining the inclination angle β using the sensor SE1 may be selectively performed.

After obtaining the inclination angle β, the controller 10 sets a final inclination correction value d based on the predetermined inclination correction amount A1 and the inclination angle β (S108), and finishes the correction value setting processing. As illustrated in FIG. 6, an inclination correction value Hβi using the reference position correction value Hi and the predetermined angle correction value Hαi is obtained according to any one of the above described expressions (4) to (6) in each line DLi of dots.

$$\begin{matrix}H β i = Hi + ( β \text{/} α ) ( H α i - Hi ) \\ = Hi + ( β \text{/} α ) Δ Hi\end{matrix}$$

$$or , H β i = Hi + f ( β \text{/} α ) \times Δ Hi$$

The obtained inclination correction value Hβi is stored in the non-volatile memory 30, for example.

As illustrated in FIG. 10, even in a case in which recording density of the ink droplets 67 using the nozzles 64 of the recording head 60 is corrected in the unit of line DL of dots, the predetermined inclination correction amount A1 may be obtained by putting a plurality of the lines DL together. For example, in a case in which the predetermined inclination correction amount A1 is obtained by putting the line DL together from a line DLi−j to a line DLi+j (j is positive integer), the predetermined inclination correction amount A1 may be obtained with respect to the intermediate line DLi, and may use the predetermined inclination correction amount A1 with respect to the line Dli, with respect to remaining lines. In this manner, the inclination correction value d is obtained according to any one of the above described expressions (4) to (6) using the reference position correction value Hi and the predetermined angle correction value Hαi with respect to the line DLi−j to the line DLi+j. In this manner, a work of obtaining the inclination correction value d in the unit of line DL of dots is reduced.

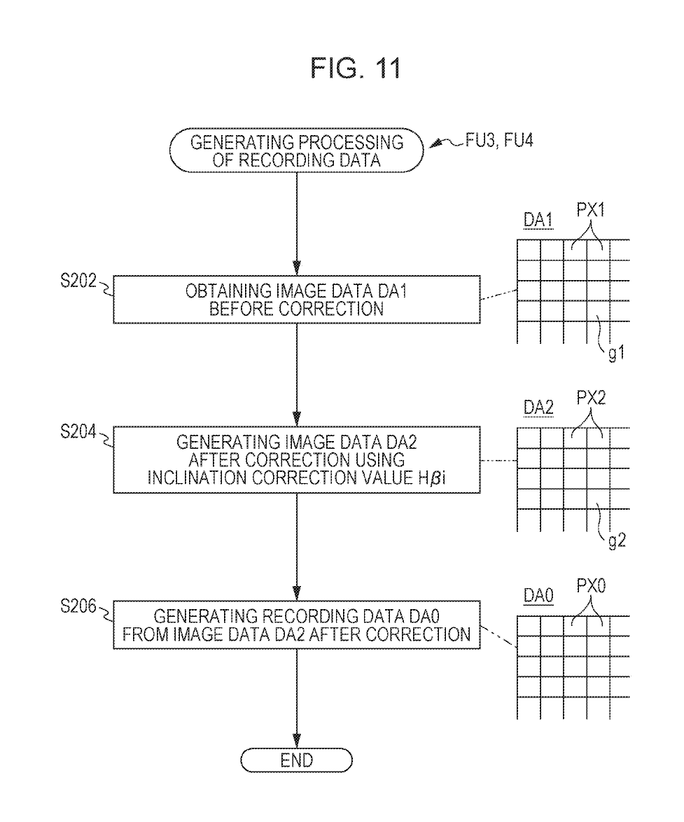

FIG. 11 illustrates an example of processing of generating recording data so that recording density of the ink droplets 67 using nozzles of the overlapping portion 212 is corrected, using the inclination correction value d. FIG. 11 schematically illustrates the image data DA1 before correction, the image data DA2 after correction, and also the recording data DA0. The recording data generating processing illustrated in FIG. 11 corresponds to the recording data generating unit U3, the recording density correcting unit U4, the recording data generating function FU3, and the recording density correcting function FU4.

When the processing is started, the controller 10 of the ink jet printer 2 obtains the CMYK data as the image data DA1 before correction (S202). The image data DA1 before correction includes a grayscale value of the CMYK data (set to g1) in each pixel PX1.

Subsequently, the controller 10 generates the image data DA2 after correction, using the inclination correction value Hβi in each line DL (S204). The image data DA2 after correction includes a grayscale value of CMYK data (set to g2) in each pixel PX2. The grayscale value g2 of each pixel PX2 can be calculated by the following expression, for example.

g2=Hβi×g1 (7)

As a matter of course, the grayscale value g1 of the pixel PX1 in the expression (7) is a grayscale value of the pixel PX1 at a position corresponding to the pixel PX2. The inclination correction value Hβi is the inclination correction value d in the line DLi including the pixel PX2. Accordingly, the image data DA1 before correction is corrected according to the inclination correction value Hβi which is set in each line DL, and finally, recording density of the ink droplets 67 using the nozzles 64 of the recording head 60 is corrected in the unit of line DL of dots.

After correcting the image data DA1, the controller 10 generates the recording data DA0 by reducing the number of grayscales of grayscale values by performing halftoning processing in the CMYK data as the image data DA2 after correction (S206), and finishes the recording data generating processing. The recording data DA0 in this case is binary data or multivalued data. The recording data DA0 includes a value denoting a formation state of dots DT0 in each pixel PX0. The driving signal SG is supplied to the driving circuit 62 based on the obtained recording data DA0, and the ink droplets 67 are ejected from each nozzle 64 of the recording head 60 according to the driving signal SG, and land onto the matter for printing ME1. In this manner, the printed image IM1 using the dots DT0 of the plurality of ink droplets 67 is formed on the matter for printing ME1. In the obtained printed image IM1, recording density of the ink droplets 67 using the nozzles 64 of the recording head 60 is corrected in the unit of line DL of dots.

As described above, recording density which is changed when the recording head 60 is inclined by the inclination angle β from the reference position P1 is corrected with respect to recording density of the ink droplets 67 using the nozzles 64 of the overlapping portion 212. In this manner, density unevenness between the non-overlapping region 221 and the overlapping region 222 is suppressed. Accordingly, according to the specific example, it is possible to suppress banding which occurs in the overlapping region.

### (4) Modification Example

Various modification examples are taken into consideration in the invention.

For example, the ink jet printer is not limited to the line printer, and may be a serial printer, or the like, in which a recording head in which a plurality of head chips are combined is reciprocated in the main scanning direction which is different from the sub-scanning direction (paper sending direction).

The output device is not limited the ink jet printer which forms a two-dimensional printed image, and may be a three-dimensional printer, or the like. Ink is not only liquid for expressing a color, and in which liquid of various types which apply some functions such as non-colored liquid which generates gloss feeling is included. Accordingly, various liquid droplets such as non-colored liquid droplets are included in the ink droplets.

The above described processing can be appropriately changed, for example, changing the order, or the like. For example, in the correction value setting processing in FIG. 7, the processing in S102 for obtaining the predetermined inclination correction amount A1 can be performed after any of processing of S104 and S106.

As illustrated in FIG. 12, the predetermined angle α for obtaining the predetermined inclination correction amount A1 may be set in a plurality of stages. FIG. 12 illustrates a state in which predetermined angle correction values Hα(1)i, Hα(2)i, and Hα(3)i are set in each line DL of dots with respect to each of the predetermined angles α(1), α(2), and α(3). These predetermined angle correction values Hα(1)i, Hα(2)i, and Hα(3)i are stored in the non-volatile memory 30 (example of predetermined inclination correction amount storage unit) along with the reference position correction value Hi. In addition, differential values Hα(1)i-Hi, Hα(2)i-Hi, and Hα(3)i-Hi may be stored in the non-volatile memory 30, instead of the predetermined angle correction values Hα(1)i, Hα(2)i, and Hα(3)i.

FIG. 13 illustrates an example of correction value setting processing in which the predetermined angle α is set in the plurality of stages. When the processing is started, the controller 10 of the ink jet printer 2 obtains the inclination angle β of the recording head 60 (S302). The processing in S302 can be set to the processing S104 to S107 which are illustrated in FIG. 7. In addition, the inclination angle β may be obtained, using the sensor SE1 which is illustrated in FIG. 9.

After obtaining the inclination angle β, the controller 10 selects a predetermined angle α(j) for obtaining the predetermined inclination correction amount A1 based on the inclination angle β (S304). The variable j here is a variable which identifies the predetermined angle α. For example, it is set to 0<α(1)<α(2)<α(3). In this case, α(1) may be selected as the predetermined angle when 0≤|β|<{α(1)+α(2)}/2, α(2) may be selected as the predetermined angle when {α(1)+α(2)}/2≤|β|<{α(2)+α(3)}/2, and α(3) may be selected as the predetermined angle when {α(2)+α(3)}2≤|β|.

After selecting the predetermined angle α(j), the controller 10 obtains a predetermined inclination correction amount A1 of the selected predetermined angle α(j) from the non-volatile memory 30 (S306). In the example illustrated in FIG. 12, the reference position correction value Hi is obtained regardless of selecting of the predetermined angle α(j), the predetermined angle correction value Hα(1)i is obtained in a case in which the predetermined angle α(1) is selected, the predetermined angle correction value Hα(2)i is obtained in a case in which the predetermined angle α(2) is selected, and the predetermined angle correction value Hα(3)i is obtained in a case in which the predetermined angle α(3) is selected.

After obtaining the predetermined inclination correction amount A1, the controller 10 sets a final inclination correction value d based on the predetermined inclination correction amount A1 and the inclination angle β (S308), and finishes the correction value setting processing. As illustrated in FIG. 12, the inclination correction value Hβi is obtained according to any one of the above described expressions (4) to (6) using the reference position correction value Hi and a predetermined angle correction value Hα(j)i, in each line DL of dots.

$$\begin{matrix}H β i = Hi + ( β \text{/} α ( j ) ) ( H α ( j ) i - Hi ) \\ = Hi + ( β \text{/} α ( j ) ) Δ Hi\end{matrix}$$

$$or , H β i = Hi + f ( β \text{/} α ( j ) ) \times Δ Hi$$

The obtained inclination correction value Hβi is stored in the non-volatile memory 30, for example.

Thereafter, as illustrated in FIG. 11, it is possible to generate the recording data DA0 so that recording density of the ink droplets 67 using the nozzles of the overlapping portion 212 is corrected, using the inclination correction value Hβi. Accordingly, when setting the predetermined angle α for obtained the predetermined inclination correction amount A1 in a plurality of stages, recording density which is changed when the recording head 60 is inclined by the inclination angle β from the reference position P1 is delicately corrected with respect to recording density of the ink droplets 67 using the nozzles 64 of the overlapping portion 212.

In S304, two or more of the predetermined angles α(j) may be selected. For example, α(1) and α(2) may be selected as the predetermined angle when {3×α(1)+α(2)}/4≤|β|≤{α(1)+3×α(2)}/4, and α(2) and α(3) may be selected as the predetermined angle when {3×α(2)+α(3)}/4≤|β|<{α(2)+3×α(3)}/4. In a case in which the predetermined angles α(1) and α(2) are selected, {Hα(1)i+Hα(2)i}/2 is used in the predetermined angle correction value b, and {Hα(2)i+Hα(3)i}/2 is used when the predetermined angles α(2) and α(3) are selected in the predetermined angle correction value b.

### (5) Conclusion

As described above, according to the invention, it is possible to provide a technology, or the like, in which it is possible to suppress banding which occurs in the overlapping region 222 using various aspects. As a matter of course, even in the technology which is configured only of constituent elements related to the independent claim, it is possible to obtain the above described basic operations and effects.

In addition, a configuration in which each configuration which is disclosed in the above described example is replaced each other, or a combination thereof is changed, a configuration in which each configuration which is disclosed in a well-known technology, and the above described example are replaced each other, or a combination thereof is changed, or the like, can be executed. The invention also includes these configurations, or the like.

This application claims priority under 35 U.S.C. § 119 to Japanese Patent Application No. 2017-045661, filed Mar. 10, 2017. The entire disclosure of Japanese Patent Application No. 2017-045661 is hereby incorporated herein by reference.

What is claimed is:

1. An image processing device which generates recording data for causing a recording head which includes an overlapping portion in which nozzles of a first nozzle column and a second nozzle column are partially overlapped in a nozzle aligning direction of a nozzle column to eject liquid droplets, the device comprising:
a predetermined inclination correction amount obtaining unit which obtains a predetermined inclination correction amount for correcting recording density which is changed when the recording head is inclined by a predetermined angle from a reference position, with respect to recording density of the liquid droplets using nozzles of the overlapping portion;
an inclination angle obtaining unit for obtaining an inclination angle of the recording head from the reference position; and
a recording data generating unit for generating the recording data so that recording density of the liquid droplets using the nozzles of the overlapping portion is corrected based on the predetermined inclination correction amount, and the inclination angle of the recording head.

2. The image processing device according to claim 1,
wherein the recording head and a matter for printing perform a relative movement in a relative movement direction which intersects the aligning direction,
wherein the predetermined inclination correction amount obtaining unit obtains a predetermined inclination correction amount for correcting recording density which is changed when the recording head is inclined by the predetermined angle from the reference position in a virtual plane including the aligning direction and the relative movement direction, and
wherein the inclination angle obtaining unit obtains an inclination angle of the recording head from the reference position in the virtual plane.

3. The image processing device according to claim 1,
wherein the predetermined inclination correction amount obtaining unit obtains the predetermined inclination correction amount based on a reference position correction value for correcting recording density of the liquid droplets using the nozzles of the overlapping portion, in a case in which the recording head is at the reference position, and a predetermined angle correction value for correcting recording density of the liquid droplets using the nozzles of the overlapping portion, in a case in which the recording head is inclined by the predetermined angle from the reference position.

4. The image processing device according to claim 1,
wherein the predetermined angle is set in a plurality of stages,
wherein a predetermined inclination correction amount storage unit in which the predetermined inclination correction amount is stored with respect to each of the predetermined angles in the plurality of stages is further provided,
wherein the predetermined inclination correction amount obtaining unit obtains one or more predetermined inclination correction amounts from the predetermined inclination correction amount storage unit based on the inclination angle of the recording head, and
wherein the recording data generating unit generates the recording data so that recording density of the liquid droplets using the nozzles of the overlapping portion is corrected based on the one or more predetermined inclination correction amounts, and the inclination angle of the recording head.

5. The image processing device according to claim 1,
wherein the inclination angle obtaining unit includes a pattern output unit which causes a printing apparatus to form a plurality of inclination angle detecting patterns in which at least one of recording density of the liquid droplets using the nozzles of the overlapping portion and recording density of the liquid droplets using the nozzles of a non-overlapping portion in which the first nozzle column and the second nozzle column are not overlapped is changed corresponding to an inclination angle of the recording head from the reference position, and obtains the inclination angle of the recording head by receiving an input of the inclination angle of the recording head.

6. The image processing device according to claim 1,
wherein the inclination angle obtaining unit includes a sensor for detecting the inclination angle of the recording head from the reference position, and obtains the detected inclination angle of the recording head.

7. The image processing device according to claim 1,
wherein the recording head and a matter for printing perform a relative movement in a relative movement direction which intersects the aligning direction,
wherein dots are formed on the matter for printing using liquid droplets from the recording head, and
wherein the recording data generating unit corrects recording density of liquid droplets using the nozzles of the recording head in a unit of line of dots which are formed along the relative movement direction.

8. The image processing device according to claim 7,
wherein the predetermined inclination correction amount obtaining unit obtains the predetermined inclination correction amount by putting a plurality of lines together.

9. An image processing program for generating recording data for causing a recording head including an overlapping portion in which nozzles of a first nozzle column and a second nozzle column are partially overlapped in a nozzle aligning direction of the nozzle column to eject liquid droplets, the program causing a computer to execute:
a function of obtaining a predetermined inclination correction amount for correcting recording density which is changed when the recording head is inclined by a predetermined angle from a reference position with respect to recording density of the liquid droplets using nozzles of the overlapping portion;
a function of obtaining an inclination angle of the recording head from the reference position; and
a function of generating recording data in which the recording data is generated so that recording density of the liquid droplets using the nozzles of the overlapping portion is corrected based on the predetermined inclination correction amount, and the inclination angle of the recording head.

10. A printing apparatus which comprising:
a recording head including an overlapping portion in which nozzles of a first nozzle column and a second nozzle column are partially overlapped in a nozzle aligning direction of the nozzle column;
a predetermined inclination correction amount obtaining unit which obtains a predetermined inclination correction amount for correcting recording density which is changed when the recording head is inclined by a predetermined angle from a reference position with respect to recording density of the ink droplets ejected from nozzles of the overlapping portion;
an inclination angle obtaining unit for obtaining an inclination angle of the recording head from the reference position; and
a recording density correcting unit for correcting recording density of the ink droplets using nozzles of the overlapping portion, based on the predetermined inclination correction amount and the inclination angle of the recording head.
